(19) United States
(12) Patent Application Publication
(10) Pub. No.: US 2015/0264587 A1
(43) Pub. Date: Sep. 17, 2015

(54) Parameter-based facilitation of interworking and network selection

(71) Applicant: BROADCOM CORPORATION, IRVINE, CA (US)

(72) Inventors: Matthew James Fischer, Mountain View, CA (US); Qi Wang, San Francisco, CA (US); Vinko Erceg, Cardiff by the Sea, CA (US); Raymond Reynolds Hayes, Los Gatos, CA (US); Mark Kent, Vista, CA (US); Florin Baboescu, Solana Beach, CA (US); Dutt Harinarayan Kalapatapu, Santa Clara, CA (US)

(73) Assignee: BROADCOM CORPORATION, IRVINE, CA (US)

(21) Appl. No.: 14/634,036

(22) Filed: Feb. 27, 2015

Related U.S. Application Data
(60) Provisional application No. 61/953,356, filed on Mar. 14, 2014.
(60) Provisional application No. 62/119,118, filed on Feb. 21, 2015.

(51) Int. Cl. H04W 24/02

(52) U.S. Cl. CPC H04W 24/02; H04W 92/02

(57) ABSTRACT

A wireless communication device (e.g., generally, a device) includes a communication interface and a processor configured to support communications with one or more other devices. In an example of operation, the device supports first communications based on a first communication protocol with a first network coordinator device and identifies a second network coordinator device that operates based on a second communication protocol when supporting those first communications. The device also determines one or more operational parameters associated with the second network coordinator device. When one or more conditions is/are appropriate, the device interworks the first communications and second communications based on the second communication protocol with the second network coordinator device. The degree of interworking is based on one or more considerations associated with one or more of the first and second communication protocols, the first and second network coordinator devices, local and/or remote operating conditions, etc.

### CROSS REFERENCE TO RELATED PATENTS/PATENT APPLICATIONS

### Provisional Priority Claims

The present U.S. Utility Patent Application claims priority pursuant to 35 U.S.C. §119(e) to U.S. Provisional App. Ser. No. 61/953,356, entitled “Parameter-based facilitation of interworking and network selection,” filed Mar. 14, 2014; and U.S. Provisional App. Ser. No. 62/119,118, entitled “Parameter-based facilitation of interworking and network selection,” filed Feb. 21, 2015, both of which are hereby incorporated herein by reference in their entirety and made part of the present U.S. Utility Patent Application for all purposes.

### BACKGROUND

1. Technical Field

The present disclosure relates generally to communication systems; and, more particularly, to interworking of communications within single user, multiple user, multiple access, and/or MIMO wireless communications.

2. Description of Related Art

Communication systems support wireless and wire lined communications between wireless and/or wire lined communication devices. The systems can range from national and/or international cellular telephone systems, to the Internet, to point-to-point in-home wireless networks and can operate in accordance with one or more communication standards. For example, wireless communication systems may operate in accordance with one or more standards including, but not limited to, IEEE 802.11x (where x may be various extensions such as a, b, n, g, etc.), Bluetooth, advanced mobile phone services (AMPS), digital AMPS, global system for mobile communications (GSM), etc., and/or variations thereof.

In some instances, wireless communication is made between a transmitter (TX) and receiver (RX) using single-input-single-output (SISO) communication. Another type of wireless communication is single-input-multiple-output (SIMO) in which a single TX processes data into radio frequency (RF) signals that are transmitted to a RX that includes two or more antennae and two or more RX paths.

Yet an alternative type of wireless communication is multiple-input-single-output (MISO) in which a TX includes two or more transmission paths that each respectively converts a corresponding portion of baseband signals into RF signals, which are transmitted via corresponding antennae to a RX. Another type of wireless communication is multiple-input-multiple-output (MIMO) in which a TX and RX each respectively includes multiple paths such that a TX parallel processes data using a spatial and time encoding function to produce two or more streams of data and a RX receives the multiple RF signals via multiple RX paths that recapture the streams of data utilizing a spatial and time decoding function.

As the number and types of various wireless communication standards continues to grow and expand, the prior art does not provide acceptable means by which wireless communication devices can operate or interact among them. A typical wireless communication device operates generally with only one given wireless communication system that is compliant with only one given wireless communication standard. There continues to be ample room for improvement in the art in regards to wireless communication device operation and management of wireless communications.

### BRIEF DESCRIPTION OF THE SEVERAL VIEWS OF THE DRAWINGS

FIG. 1 is a diagram illustrating an embodiment of a wireless communication system.

FIG. 2 is a diagram illustrating an embodiment of dense deployment of wireless communication devices.

FIG. 3A is a diagram illustrating an example of communication between wireless communication devices.

FIG. 3B is a diagram illustrating another example of communication between wireless communication devices.

FIG. 3C is a diagram illustrating another example of communication between wireless communication devices.

FIG. 3D is a diagram illustrating another example of communication between wireless communication devices.

FIG. 4A is a diagram illustrating an example of orthogonal frequency division multiplexing (OFDM) and/or orthogonal frequency division multiple access (OFDMA).

FIG. 4B is a diagram illustrating another example of OFDM and/or OFDMA.

FIG. 4C is a diagram illustrating another example of OFDM and/or OFDMA.

FIG. 4D is a diagram illustrating another example of OFDM and/or OFDMA.

FIG. 5A is a diagram illustrating an example of communications between communication devices to determine one or more operational parameters.

FIG. 5B is a diagram illustrating another example of communications between communication devices to determine one or more operational parameters.

FIG. 5C is a diagram illustrating another example of communications between communication devices to determine one or more operational parameters.

FIG. 6A is a diagram illustrating an example of determining one or more operational parameters and comparing them to one or more predetermined operational parameters.

FIG. 6B is a diagram illustrating another example of communication between wireless communication devices.

FIG. 6C is a diagram illustrating an example of various types of operational parameters.

FIG. 7A is a diagram illustrating an example of interworking communications using cellular and wireless local area network (WLAN) communications.

FIG. 7B is a diagram illustrating another example of interworking communications using cellular and WLAN communications.

FIG. 7C is a diagram illustrating an example of interworking communications using communications associated with different network coordinator devices.

FIG. 7D is a diagram illustrating another example of interworking communications using communications associated with different network coordinator devices.

FIG. 8A is a diagram illustrating an embodiment of a method for execution by one or more wireless communication devices.

FIG. 8B is a diagram illustrating another embodiment of a method for execution by one or more wireless communication devices.

FIG. 8C is a diagram illustrating another embodiment of a method for execution by one or more wireless communication devices.

### DETAILED DESCRIPTION

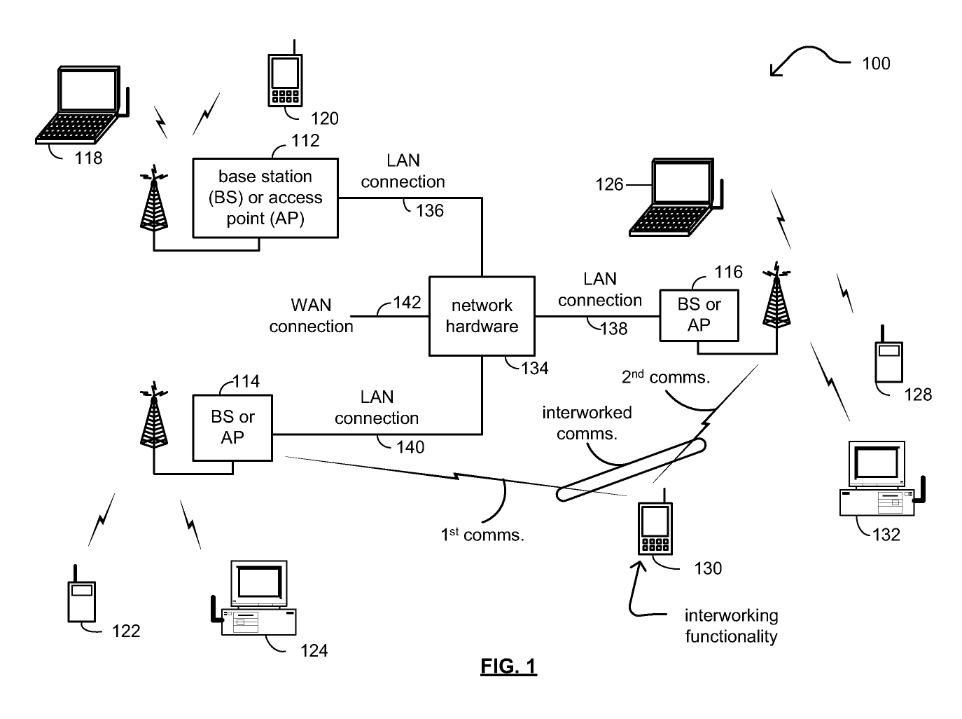

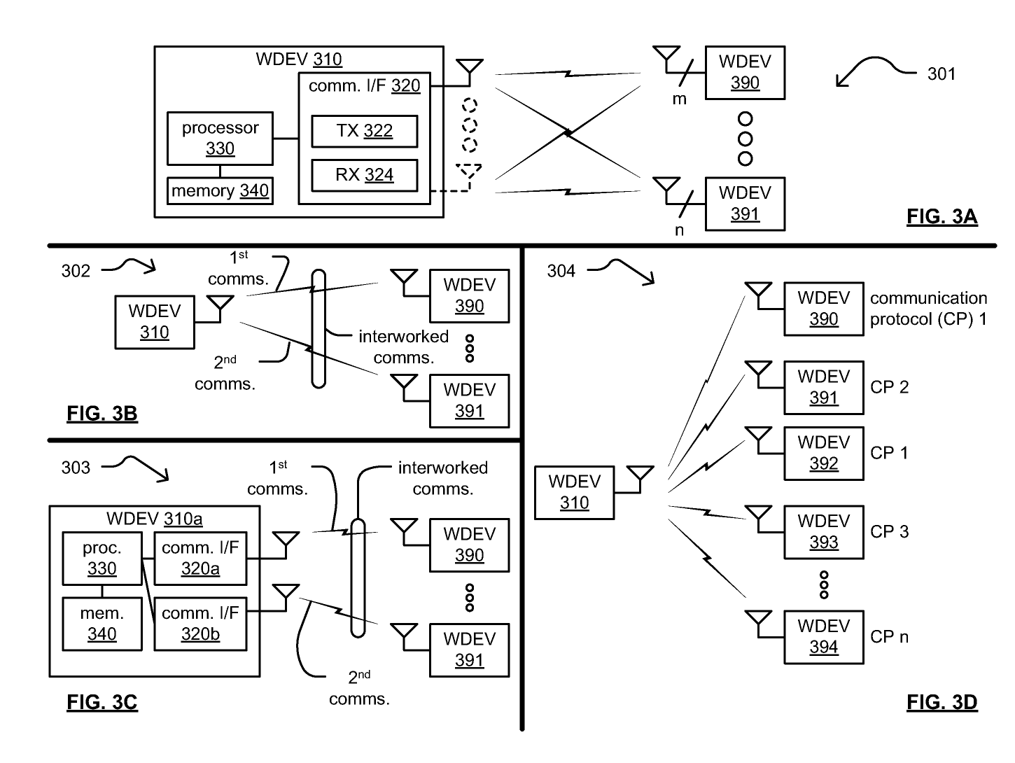

FIG. 1 is a diagram illustrating an embodiment of a wireless communication system 100. The wireless communication system 100 includes base stations and/or access points 112-116, wireless communication devices 118-132 (e.g., wireless stations (STAs)), and a network hardware component 134. The wireless communication devices 118-132 may be laptop computers, or tablets, 118 and 126, personal digital assistants 120 and 130, personal computers 124 and 132 and/or cellular telephones 122 and 128. The details of an embodiment of such wireless communication devices are described in greater detail with reference to FIG. 3A.

The base stations (BSs) or access points (APs) 112-116 are operably coupled to the network hardware 134 via local area network connections 136, 138, and 140. The network hardware 134, which may be a router, switch, bridge, modem, system controller, etc., provides a wide area network connection 142 for the communication system 100. Each of the base stations or access points 112-116 has an associated antenna or antenna array to communicate with the wireless communication devices in its area. Typically, the wireless communication devices register with a particular base station or access point 112-116 to receive services from the communication system 100. For direct connections (i.e., point-to-point communications), wireless communication devices communicate directly via an allocated channel.

Any of the various wireless communication devices (WDEVs) 118-132 and BSs or APs 112-116 may include a processor and a communication interface to support communications with any other of the wireless communication devices 118-132 and BSs or APs 112-116. In an example of operation, a processor and a communication interface implemented within one of the devices (e.g., any one of the WDEVs 118-132 and BSs or APs 112-116) are configured to process at least one signal received from and/or to generate at least one signal to be transmitted to another one of the devices (e.g., any other one of the WDEVs 118-132 and BSs or APs 112-116).

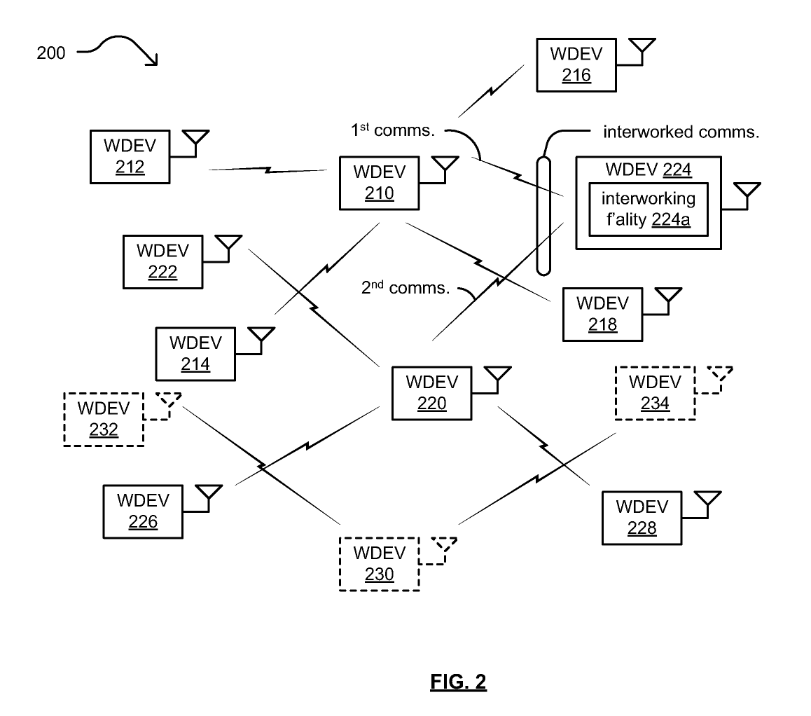

Note that general reference to a communication device, such as a wireless communication device (e.g., WDEVs) 118-132 and BSs or APs 112-116 in FIG. 1, or any other communication devices and/or wireless communication devices may alternatively be made generally herein using the term ‘device’ (e.g., with respect to FIG. 2 below, “device 210” when referring to “wireless communication device 210” or “WDEV 210,” or “devices 210-234” when referring to “wireless communication devices 210-234”; or with respect to FIG. 3A below, use of “device 310” may alternatively be used when referring to “wireless communication device 310”, or “devices 390 and 391 (or 390-391)” when referring to wireless communication devices 390 and 391 or WDEVs 390 and 391). Generally, such general references or designations of devices may be used interchangeably.

The processor and the communication interface of any one of the various devices, WDEVs 118-132 and BSs or APs 112-116, may be configured to support communications with any other of the various devices, WDEVs 118-132 and BSs or APs 112-116. Such communications may be uni-directional or bi-directional between devices. Also, such communications may be uni-directional between devices at one time and bi-directional between those devices at another time.

In an example of operation, the device 130 includes a communication interface and a processor configured to support communications with other device(s) (e.g., including BS/AP 114 and BS/AP 116). Note that the device may also be configured to support communications with other devices in the system (e.g., devices 132, 124, etc.) directly and/or indirectly (e.g., via BS/AP 114, BS/AP 116, and/or BS/AP 112, etc.).

In an example of operation, the device 130 supports first communications based on a first communication protocol with a first network coordinator device 114 and identifies a second network coordinator device 116 that operates based on a second communication protocol when supporting those first communications. The device 130 also determines operational parameter(s) associated with the second network coordinator device 116. Generally speaking, a network coordinator device may be viewed as being a BS or AP that operates based on a given communication protocol and services communications based on a particular type of wireless communication network (e.g., cellular, WLAN, Bluetooth, Zigbee, etc.).

When condition(s) is/are appropriate, the device 130 interworks the first communications and second communications based on the second communication protocol with the second network coordinator device 116. Generally speaking, interworking may be understood as offloading at least some of the first communications of a first communication link between device 130 and first network coordinator device 114 to a second communication link between device 130 and second network coordinator device 116.

The degree of interworking of the first and second communications supported by the device 130 with first network coordinator device 114 and second network coordinator device 116 is based on one or more considerations associated with one or more of the first and second communication protocols, the first and second network coordinator devices 114 and 116, local and/or remote operating conditions of any of the devices 132, 114, and 116, etc. Note also the device 130 may operate to use different interworking parameters based on different conditions (e.g., use first interworking parameter(s) based on first condition(s), use second interworking parameter(s) based on second condition(s), etc.). Some examples of considerations can include data rate, noise, interference, signal to noise ratio (SNR), signal to interference noise ratio (SINR), uplink and/or downlink speeds, prior operational history, current operational status, etc. and/or any other considerations that may characterize the operational conditions associated with the communications with the first and second network coordinator devices 114 and 116.

In other example operation, the device 130 supports the first and second communications with the first and second network coordinator devices 114 and 116 by interworking the first and second communications based on the operational parameter(s) associated with the second network coordinator device meeting one or more constraints. For example, when the operational parameter(s) associated with the second network coordinator device 116 meet or exceed predetermined operational parameter(s), then the device 130 interworks the first and second communications and maintains only the first communications when they do not meet or exceed the predetermined operational parameter(s).

These predetermined operational parameters can include fixed parameters (e.g., determined beforehand, a priori, off-line, etc.), adaptive parameters (e.g., determined by one of the devices within the system, based on local and/or remote operating conditions and/or changes thereof, etc.), modified parameters (e.g., parameters that have been updated or changed based on any consideration(s)), etc. Generally, these predetermined operational parameter(s) serve as the parameters to which the determined operational parameter(s) associated with the second network coordinator device are compared 116. When a sufficient number of the comparisons are favorable, then the device 130 interworks the first and second communications. This determination of favorable comparisons is made based on whether a threshold number of the operational parameter(s) associated with the second network coordinator device 116 meet or exceed the predetermined operational parameter(s). This threshold number may be a fixed, adaptive, etc. based on any one or more considerations, and different thresholds may be used at different times.

In another example, the device 130 scans for and identifies network coordinator device(s) (e.g., 116, 112, etc.) when supporting communications with a given network coordinator device (e.g., device 114). The device 130 then selects one of those other network coordinator devices, when conditions are appropriate, for use to interwork communications with the first given network coordinator device (e.g., device 114) and a second selected network coordinator device (e.g., device 116). Generally, in this example, one other network coordinator device is selected from among two or more other network coordinator devices based on one or more considerations.

In one implementation, consider that a first network coordinator device (e.g., BS/AP 114) operates based on cellular communication protocol, standard, and/or recommended practice, and a second network coordinator device (e.g., BS/AP 116) operates based on a wireless local area network (WLAN/WiFi) communication protocol, standard, and/or recommended practice. In another implementation, BS/AP 114 operates based on WLAN/WiFi, and BS/AP 116 operates based on cellular. In even other examples, know that any type of wireless communication protocols may be supported by the various network coordinator devices (e.g., including cellular, WLAN, Bluetooth, WiMAX (Worldwide Interoperability for Microwave Access), Zigbee, etc. of any version, amendment, etc. and/or any other type of wireless communication protocols, standards, and/or recommended practices).

FIG. 2 is a diagram illustrating an embodiment 200 of dense deployment of wireless communication devices (shown as WDEVs in the diagram). Any of the various WDEVs 210-234 may be access points (APs) or wireless stations (STAs). For example, WDEV 210 may be an AP or an AP-operative STA that communicates with WDEVs 212, 214, 216, and 218 that are STAs. WDEV 220 may be an AP or an AP-operative STA that communicates with WDEVs 222, 224, 226, and 228 that are STAs. In certain instances, at least one additional AP or AP-operative STA may be deployed, such as WDEV 230 that communicates with WDEVs 232 and 234 that are STAs. The STAs may be any type of one or more wireless communication device types including wireless communication devices 118-132, and the APs or AP-operative STAs may be any type of one or more wireless communication devices including as BSs or APs 112-116. Different groups of the WDEVs 210-234 may be partitioned into different basic services sets (BSSs). In some instances, at least one of the WDEVs 210-234 are included within at least one overlapping basic services set (OBSS) that cover two or more BSSs. As described above with the association of WDEVs in an AP-STA relationship, one of the WDEVs may be operative as an AP and certain of the WDEVs can be implemented within the same basic services set (BSS).

This disclosure presents novel architectures, methods, approaches, etc. that allow for improved spatial re-use for next generation WiFi or wireless local area network (WLAN) systems. Next generation WiFi systems are expected to improve performance in dense deployments where many clients and APs are packed in a given area (e.g., which may be an area [indoor and/or outdoor] with a high density of devices, such as a train station, airport, stadium, building, shopping mall, arenas, convention centers, colleges, downtown city centers, etc. to name just some examples). Large numbers of devices operating within a given area can be problematic if not impossible using prior technologies.

In an example of operation, the WDEV 224 is a non-AP wireless communication device, and the WDEVs 210 and 220 are APs or AP-operative STAs. The WDEV 224, which includes interworking functionality 224a, supports first communications based on a first communication protocol with WDEV 210 and identifies WDEV 220 that operates based on a second communication protocol when supporting those first communications. The WDEV 224 also determines one or more operational parameters associated with WDEV 220. When one or more conditions is/are appropriate, the WDEV 224 interworks the first communications and second communications based on the second communication protocol with the second network coordinator device 116. The degree of interworking of the first and second communications supported by the WDEV 224 with WDEV 210 and WDEV 220 is based on one or more considerations associated with one or more of the first and second communication protocols, the WDEVs 210 and 220, local and/or remote operating conditions of any of the devices 224, 210, and 220, etc.

FIG. 3A is a diagram illustrating an example 301 of communication between wireless communication devices. A wireless communication device 310 (e.g., which may be any one of devices 118-132 as with reference to FIG. 1) is in communication with another wireless communication device 390 via a transmission medium. The wireless communication device 310 includes a communication interface 320 to perform transmitting and receiving of at least one packet or frame (e.g., using a transmitter 322 and a receiver 324) (note that general reference to packet or frame may be used interchangeably).

Generally speaking, the communication interface 320 is implemented to perform any such operations of an analog front end (AFE) and/or physical layer (PHY) transmitter, receiver, and/or transceiver. Examples of such operations may include any one or more of various operations including conversions between the frequency and analog or continuous time domains (e.g., such as the operations performed by a digital to analog converter (DAC) and/or an analog to digital converter (ADC)), gain adjustment including scaling, filtering (e.g., in either the digital or analog domains), frequency conversion (e.g., such as frequency upscaling and/or frequency downscaling, such as to a baseband frequency at which one or more of the components of the device 310 operates), equalization, pre-equalization, metric generation, symbol mapping and/or de-mapping, automatic gain control (AGC) operations, and/or any other operations that may be performed by an AFE and/or PHY component within a wireless communication device.

The wireless communication device 310 also includes a processor 330, and an associated memory 340, to execute various operations including interpreting at least one signal, symbol, packet, and/or frame transmitted to wireless communication device 390 and/or received from the wireless communication device 390 and/or wireless communication device 391. The wireless communication devices 310 and 390 (and/or 391) may be implemented using at least one integrated circuit in accordance with any desired configuration or combination of components, modules, etc. within at least one integrated circuit. Also, the wireless communication devices 310, 390, and 391 may each include one or more antennas for transmitting and/or receiving of at least one packet or frame (e.g., WDEV 390 may include m antennae, and WDEV 391 may include n antennae).

FIG. 3B is a diagram illustrating another example 302 of communication between wireless communication devices. The WDEV 310 includes a communication interface and a processor that are configured to support first communications based on a first communication protocol with a first network coordinator device (e.g., WDEV 390). When supporting the first communications with WDEV 390, the WDEV 310 identifies a second network coordinator device (e.g., WDEV 391) that operates based on a second communication protocol, and the WDEV 310 determines one or more operational parameters associated with the WDEV 391 second network coordinator device that operates based on the second communication protocol.

When a threshold number of the one or more operational parameters associated with the second network coordinator device compares favorably with one or more predetermined operational parameters, the WDEV 310 interworks the first communications based on the first communication protocol with the WDEV 390 and second communications based on the second communication protocol with the WDEV 391. In a sample of such interworking of the first and second communications, at least some of the first communications are offloaded and supported within the second communications. The WDEV 310 then supports communications via both of the WDEV 390 and the WDEV 391 based on two different communication protocols (e.g., first with WDEV 390, and second with the WDEV 391).

The WDEV 310 operates to determine whether or not to perform such interworking of the first and second communications based on one or more operational parameters. Examples of the one or more operational parameters can include any one or more of a channel utilization per access category operational parameter that indicates a percentage estimate amount of time that the second network coordinator device is busy on a communication medium for communications each of one or more access categories (e.g., voice, video, best effort, background), a basic services set (BSS) load operational parameter, a link throughput operational parameter, a link measurement operational parameter, a channel load operational parameter, a Quality of Service (QoS) traffic capability operational parameter, a BSS average access delay operational parameter, a BSS available admission capacity per user priority (UP)/AC (Access Category) operational parameter, a Qload report operational parameter, an AC station count operational parameter, a wireless station (STA) statistics operational parameter, an access point (AP) channel report operational parameter, a neighbor report operational parameter, a wide area network (WAN) metrics operational parameter, a location information operational parameter, and/or any other operational parameter.

In one particular implementation, the WDEV 310 may be implemented to support communications with two or more wireless communication standards, protocols, and/or recommended practices (e.g., cellular and WLAN communication capabilities; cellular, WiMAX, WLAN communication capabilities; cellular and Bluetooth communication capabilities; cellular, WLAN, and Bluetooth communication capabilities; etc.). Generally, the WDEV 310 may be implemented to support any combination of two or more such wireless communication standards, protocols, and/or recommended practices. Many examples are provided herein of a device that includes both cellular and WLAN communication capabilities, yet note that the principles described with respect to such examples may be extended to any different types and/or combinations of wireless communication standards, protocols, and/or recommended practices.

In one example operation, the WDEV 310 includes both cellular and WiFi communication capabilities and operates within both of the respective wireless communication systems. The WDEV 310 is configured to decide when to use a cellular network and when to use a WiFi network for communication. For example, WDEV 310 is configured to communicate with WDEVs 390 and 391 via different wireless communication systems. For example, WDEV 310 is configured to communicate with WDEV 390 via a wireless local area network (WLAN/WiFi) wireless communication system, and WDEV 310 may be configured to communicate with WDEV 391 via a cellular communication system. Generally, WDEV 310 is configured to support communications with other WDEVs using more than one respective wireless communication system (e.g., either directly or indirectly via one or more network coordinator devices). WDEV 310 is implemented to include functionality for each of the respective wireless communication systems or to include capability that can adapt and change its operation to comply with each of the respective wireless application systems.

Consider that a WLAN/WiFi system and a cellular system have respective coverage areas that have at least some overlap (e.g., all, less than all, some, etc. overlap in coverage). Consider that certain regions or serviced by both of the systems while other regions are serviced by only one of the systems. When the WDEV 310 is within range of both systems, the WDEV 310 can communicate using either one or both wireless communication systems. When the WDEV 310 is within range of only one of the two systems, WDEV 310 may be configured to communicate using only that one of the respective wireless communication systems.

In some examples, the WDEV 310 is configured to support communications using any one or more of a number of WLAN parameters are specified in references [1], [2], and [3] listed below which are hereby incorporated by reference herein for all purposes.

[1] IEEE P802.11-REVmc_D2.0, IEEE Standard for Information Technology—Telecommunications and information exchange between systems, local and metropolitan area networks—Specific requirements, Part 11: Wireless LAN Medium Access Control (MAC) and Physical Layer (PHY) Specifications.

[2] WiFi Alliance Technical Committee Hotspot 2.0 Technical Task Group, Hotspot 2.0 (Release 1) Technical Specification, Version 1.0.0.

[3] IEEE Std 802.11™-2012, IEEE Standard for Information technology—

Telecommunications and information exchange between systems Local and metropolitan area networks—Specific requirements, Part 11: Wireless LAN Medium Access Control (MAC) and Physical Layer (PHY) Specifications, IEEE Computer Society, Sponsored by the LAN/MAN Standards Committee, IEEE Std 802.11™-2012 (Revision of IEEE Std 802.11-2007), 29 Mar. 2012.

This disclosure describes various WLAN (Wireless Local Area Network) QoS (Quality of Service) and non-QoS parameters, and a wireless communication device may be configured to use of any desired combination of any operational parameters (e.g., existing and/or new WLAN parameters, existing and/or new cellular parameters, etc.) to facilitate interworking and network selection including based on at least the following operational scenarios:

Scenario 1: Interworking between the cellular network and WiFi network where traffic is offloaded from a cellular network onto a WLAN network.

Scenario 2: Network selection where traffic is switched from one WLAN BSS (Basic Serve Set) to another WLAN BSS (i.e., roaming).

Scenario 3: Interworking where traffic is switched from a WLAN/WiFi network to a cellular network.

Note that reference to WLAN, WiFi, and/or WLAN/WiFi may be used interchangeably herein.

FIG. 3C is a diagram illustrating another example 303 of communication between wireless communication devices. In this example 303, the WDEV 310a includes a processor 330, memory 340, and also first communication interface 320a, and a second communication interface 320b. The first communication interface 320a is configured to support first communications with WDEV 390 based on a first communication protocol, and the second communication interface 320a is configured to support second communications with WDEV 391 based on a second communication protocol. The processor 340 is configured to coordinate the first and second communications based on the first and second communication protocols with the other WDEVs 390-391 including appropriately performing interworking between them both. Note that more than two communication interfaces may be implemented within a given example of a wireless communication device (e.g., N communication interfaces, where N is a positive integer greater than or equal to 1) such that each communication interface supports different communication protocol. Alternatively, other examples herein shall a single communication interface that is configured to support communications based on two or more communication protocols.

FIG. 3D is a diagram illustrating another example 304 of communication between wireless communication devices. In this diagram, the WDEV 310 is configured to support communications with any number of other WDEVs 390, 391, 392, 393, and up to 394 based on one or more communication protocols. More than one of the WDEVs 390-394 may operate based on a common communication protocol. For example, the WDEVs 390 and 392 may operate based on a first communication protocol, the WDEV 391 may operate based on a second communication protocol, the WDEV 393 may operate based on a third communication protocol, and WDEV 394 may operate based on an n-th communication protocol. The WDEV 310 is configured to adapt communications among the various WDEVs 390-394 including interworking communications among any combination of two or more of the WDEVs 390-394 using any combination of communication protocols. For example, at or during a first time (ΔT1), the WDEV 310 is configured to support first and second communications with WDEVs 390-391, respectively, based on the second and first communication protocols, respectively. For another example, at or during a second time (ΔT2), the WDEV 310 is configured to support first and second communications with WDEVs 392-393, respectively, based on the first and third communication protocols, respectively. For yet another example, at or during a second time (ΔT2), the WDEV 310 is configured to support first and second communications with WDEVs 392, 391, and 393, respectively, based on the first, second, and third communication protocols, respectively.

In another example of operation, the WDEV 310 is configured to scan for and identify a number of network coordinator devices (e.g., WDEVs 391-394) that operate based on the one or more communication protocols when supporting first communications with a first network coordinator device (e.g., WDEV 390) based on a first communication protocol. The WDEV 310 is then configured to identify one of those network coordinator devices (e.g., WDEV 391 from among WDEVs 391-394) that operate based on a second communication protocol based on the threshold number of the one or more operational parameters associated with the second network coordinator device comparing favorably with the one or more predetermined operational parameters.

In another example, the WDEV 310 is configured to support only the first communications based on the first communication protocol with the first network coordinator device (e.g., WDEV 390) and identify a third network coordinator device (e.g., such as WDEV 393 from among WDEVs 391-394) that operates based on another communication protocol when supporting the first communications when less than the threshold number of the one or more operational parameters associated with the second network coordinator device compares favorably with the one or more predetermined operational parameters. The WDEV 310 is then configured to determine another one or more operational parameters associated with the third network coordinator device (e.g., WDEV 393) that operates based on this other communication protocol when supporting only the first communications. The WDEV 310 is then configured to interwork the first communications based on the first communication protocol with the first network coordinator device and third communications based on this other communication protocol with the third network coordinator device (e.g., WDEV 393) when another threshold number of the another one or more operational parameters associated with the third network coordinator device compares favorably with the one or more predetermined operational parameters.

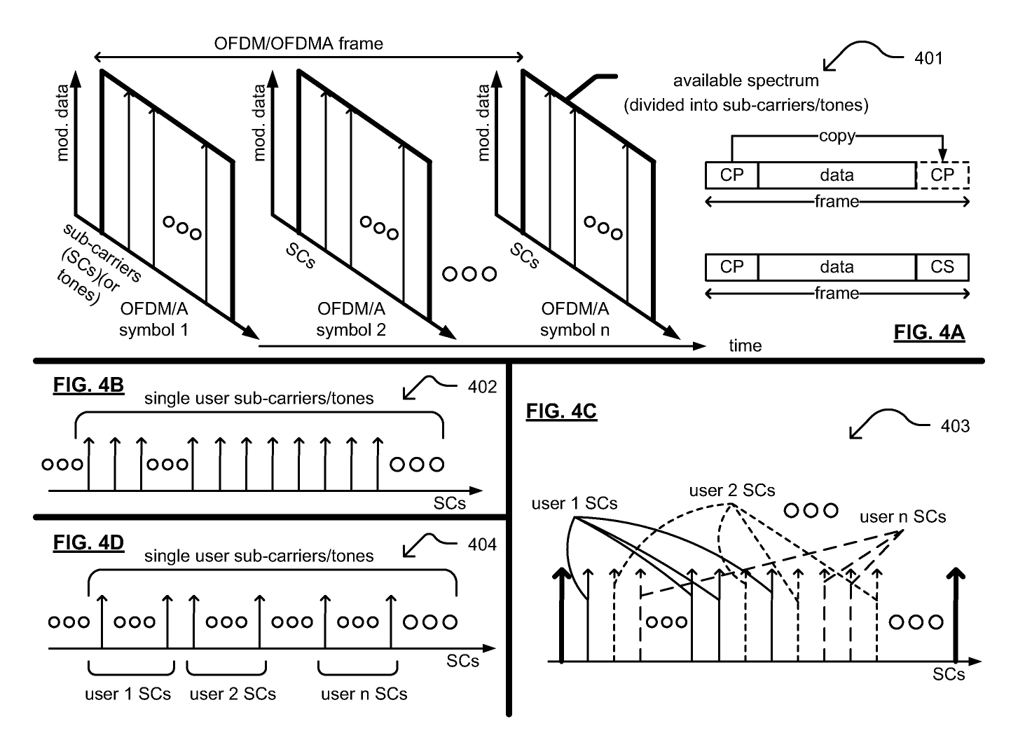

FIG. 4A is a diagram illustrating an example 401 of orthogonal frequency division multiplexing (OFDM) and/or orthogonal frequency division multiple access (OFDMA). OFDM's modulation may be viewed as dividing up an available spectrum into a plurality of narrowband sub-carriers (e.g., relatively lower data rate carriers). The sub-carriers are included within an available frequency spectrum portion or band. This available frequency spectrum is divided into the sub-carriers or tones used for the OFDM or OFDMA symbols and packets/frames. Typically, the frequency responses of these sub-carriers are non-overlapping and orthogonal. Each sub-carrier may be modulated using any of a variety of modulation coding techniques (e.g., as shown by the vertical axis of modulated data).

A communication device may be configured to perform encoding of one or more bits to generate one or more coded bits used to generate the modulation data (or generally, data). For example, a processor and the communication interface of a communication device may be configured to perform forward error correction (FEC) and/or error correction code (ECC) of one or more bits to generate one or more coded bits. Examples of FEC and/or ECC may include turbo code, convolutional code, turbo trellis coded modulation (TTCM), low density parity check (LDPC) code, Reed-Solomon (RS) code, BCH (Bose and Ray-Chaudhuri, and Hocquenghem) code, etc. The one or more coded bits may then undergo modulation or symbol mapping to generate modulation symbols. The modulation symbols may include data intended for one or more recipient devices. Note that such modulation symbols may be generated using any of various types of modulation coding techniques. Examples of such modulation coding techniques may include binary phase shift keying (BPSK), quadrature phase shift keying (QPSK), 8-phase shift keying (PSK), 16 quadrature amplitude modulation (QAM), 32 amplitude and phase shift keying (APSK), etc., uncoded modulation, and/or any other desired types of modulation including higher ordered modulations that may include even greater number of constellation points (e.g., 1024 QAM, etc.).

FIG. 4B is a diagram illustrating another example 402 of OFDM and/or OFDMA. A transmitting device transmits modulation symbols via the sub-carriers. OFDM and/or OFDMA modulation may operate by performing simultaneous transmission of a large number of narrowband carriers (or multi-tones). In some applications, a guard interval (GI) or guard space is sometimes employed between the various OFDM symbols to try to minimize the effects of ISI (Inter-Symbol Interference) that may be caused by the effects of multi-path within the communication system, which can be particularly of concern in wireless communication systems. In addition, a cyclic prefix (CP) and/or cyclic suffix (CS) (shown in right hand side of FIG. 4A) that may be a copy of the CP may also be employed within the guard interval to allow switching time (e.g., such as when jumping to a new communication channel or sub-channel) and to help maintain orthogonality of the OFDM and/or OFDMA symbols. Generally speaking, an OFDM and/or OFDMA system design is based on the expected delay spread within the communication system (e.g., the expected delay spread of the communication channel).

In a single-user system in which one or more OFDM symbols or OFDM packets/frames are transmitted between a transmitter device and a receiver device, all of the sub-carriers or tones are dedicated for use in transmitting modulated data between the transmitter and receiver devices. In a multiple user system in which one or more OFDM symbols or OFDM packets/frames are transmitted between a transmitter device and multiple recipient or receiver devices, the various sub-carriers or tones may be mapped to different respective receiver devices as described below with respect to FIG. 4C.

FIG. 4C is a diagram illustrating another example 403 of OFDM and/or OFDMA. Comparing OFDMA to OFDM, OFDMA is a multi-user version of the popular orthogonal frequency division multiplexing (OFDM) digital modulation scheme. Multiple access is achieved in OFDMA by assigning subsets of subcarriers to individual recipient devices or users. For example, first sub-carrier(s)/tone(s) may be assigned to a user 1, second sub-carrier(s)/tone(s) may be assigned to a user 2, and so on up to any desired number of users. In addition, such sub-carrier/tone assignment may be dynamic among different respective transmissions (e.g., a first assignment for a first packet/frame, a second assignment for second packet/frame, etc.). An OFDM packet/frame may include more than one OFDM symbol. Similarly, an OFDMA packet/frame may include more than one OFDMA symbol. In addition, such sub-carrier/tone assignment may be dynamic among different respective symbols within a given packet/frame or superframe (e.g., a first assignment for a first OFDMA symbol within a packet/frame, a second assignment for a second OFDMA symbol within the packet/frame, etc.). Generally speaking, an OFDMA symbol is a particular type of OFDM symbol, and general reference to OFDM symbol herein includes both OFDM and OFDMA symbols (and general reference to OFDM packet/frame herein includes both OFDM and OFDMA packets/frames, and vice versa). FIG. 4C shows example 403 where the assignments of sub-carriers to different users are intermingled among one another (e.g., sub-carriers assigned to a first user includes non-adjacent sub-carriers and at least one sub-carrier assigned to a second user is located in between two sub-carriers assigned to the first user). The different groups of sub-carriers associated with each user may be viewed as being respective channels of a plurality of channels that compose all of the available sub-carriers for OFDM signaling.

FIG. 4D is a diagram illustrating another example 404 of OFDM and/or OFDMA. In this example 404, the assignments of sub-carriers to different users are located in different groups of adjacent sub-carriers (e.g., first sub-carriers assigned to a first user include first adjacently located sub-carrier group, second sub-carriers assigned to a second user include second adjacently located sub-carrier group, etc.). The different groups of adjacently located sub-carriers associated with each user may be viewed as being respective channels of a plurality of channels that compose all of the available sub-carriers for OFDM signaling.

Generally, a communication device may be configured to include a processor and the communication interface configured to process received OFDM or OFDMA symbols and/or frames and to generate such OFDM or OFDMA symbols and/or frames. The processor and the communication interface of the communication device are configured to support communications with one or more other communication devices based on one or more communication protocols including interworking of communications with any combination of two or more other communication devices based on any combination of communication protocols. Note also that any characteristics and/or operational parameters associated with OFDMA and/or OFDMA signaling made serve as one or more of the operational parameters used to determine whether and when to perform interworking of communications. Note also that selectivity between frequency bands, channels, sub-carriers, clusters or combinations of one or more sub-carriers within any one or more channels and/or frequency bands may be performed to support such communications including interworked communications. Note that different frequency bands, channels, sub-carriers, etc. may be used for different communication protocols. A wireless communication device may be configured to perform adaptation among those frequency bands, channels, sub-carriers, etc. that are assigned for different purposes and/or different users based on any consideration(s).

A wireless communication device may be configured to determine one or more operational parameters associated with any network coordinator device using various means including prior and/or ongoing communications with the network coordinator device, probe request and response mechanisms, various frame exchanges including management frame exchanges, etc.

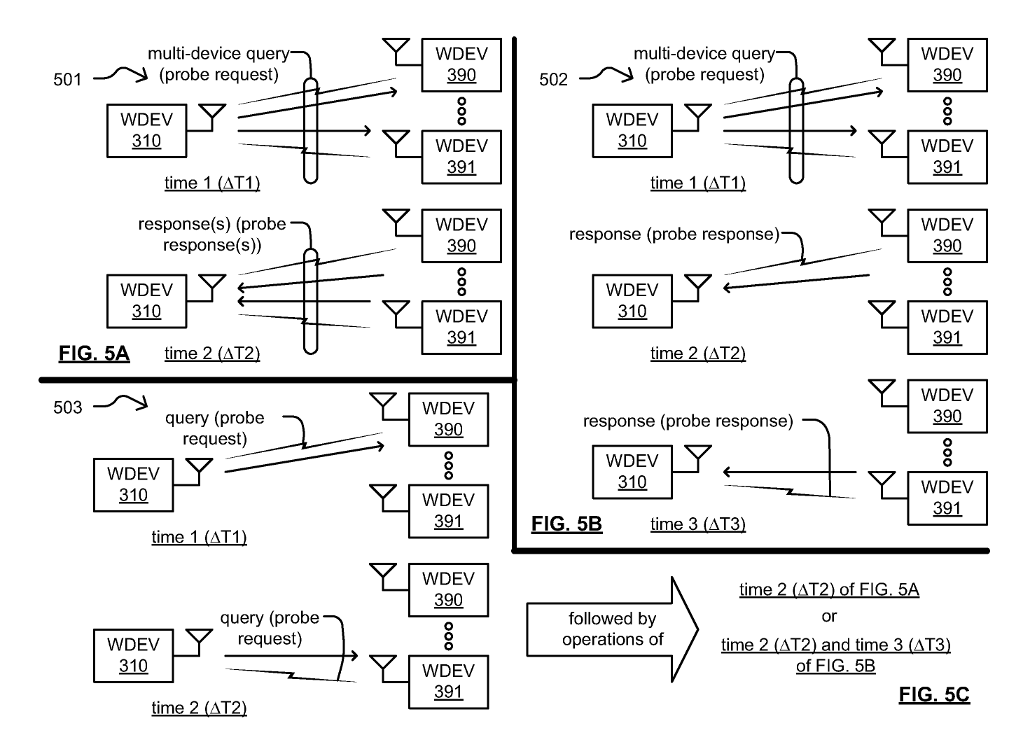

FIG. 5A is a diagram illustrating an example 501 of communications between communication devices to determine one or more operational parameters. In this diagram, at or during a time 1 (ΔT1), the device 310 transmits a multi-device query to devices 390-391. This multi-device query may be a probe request that is transmitted to two or more other devices. Such signaling may be based on MU-MIMO and/or OFDMA. Then, at or during a time 2 (ΔT2), the device 310 receives one or more responses (e.g., one or more probe responses) from the devices 390-391. The multi-device query may request information regarding any one or more operational parameters, and the one or more responses will include and provide such requested information.

FIG. 5B is a diagram illustrating another example 502 of communications between communication devices to determine one or more operational parameters. In this diagram, at or during a time 1 (ΔT1), the device 310 transmits a multi-device query (e.g., multi-device probe request) to devices 390-391. Then, at or during a time 2 (ΔT2), the device 310 receives a first response (e.g., a first probe response) from the device 390. Then, at or during a time 3 (ΔT3), the device 310 receives a second response (e.g., a first second response) from the device 391.

FIG. 5C is a diagram illustrating another example 503 of communications between communication devices to determine one or more operational parameters. In this diagram, at or during a time 1 (ΔT1), the device 310 transmits a first query (e.g., first probe request) to devices 390. Then, at or during a time 2 (ΔT2), the device 310 transmits a second query (e.g., second probe request) to devices 391. Then, the communications between device 310 and devices 390-391 follow those performed at or during a time 2 (ΔT2) in FIG. 5A or at or during a time 2 (ΔT2) and at or during a time 3 (ΔT3) in FIG. 5B.

Generally speaking, any desired interaction, frame exchange, probe request/response, etc. may be performed between devices to determine the one or more operational parameters associated with the various devices is a system.

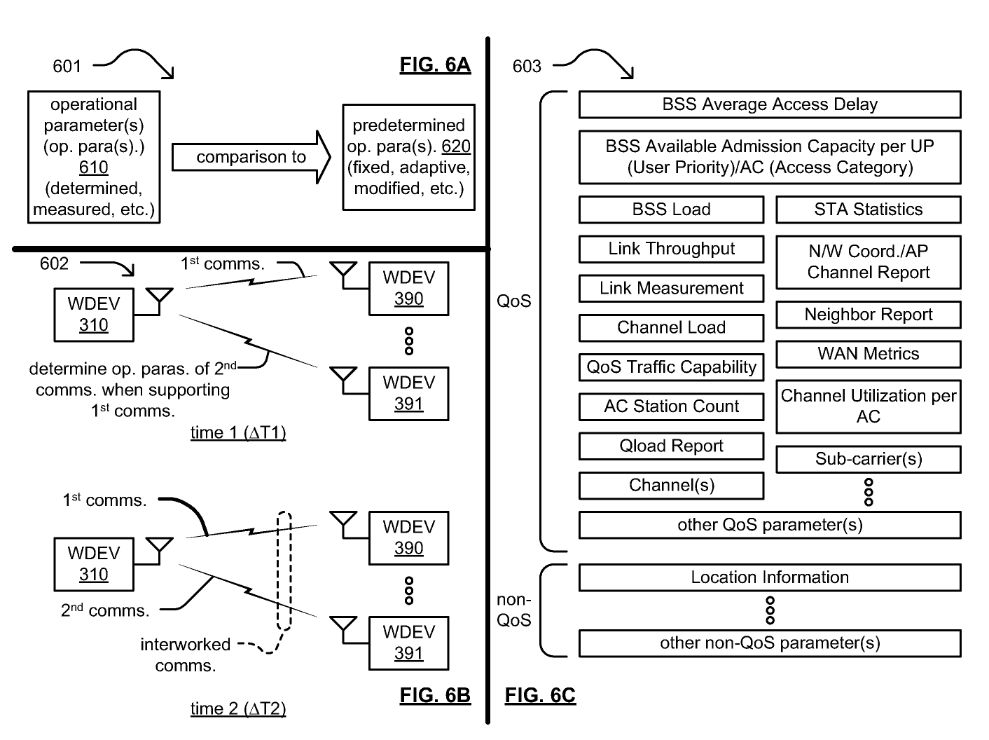

FIG. 6A is a diagram illustrating an example 601 of determining one or more operational parameters and comparing them to one or more predetermined operational parameters. In this diagram, the determined, measured, etc. one or more operational parameters associated with a network coordinator device, as shown by reference numeral 610, undergo comparison with one or more predetermined operational parameters, as shown by reference numeral 620. As described elsewhere herein, such operational parameters may be fixed, adaptive, modified, etc. in general, the one or more predetermined operational parameters serve as the basis for comparison with the determined, measured, etc. one or more operational parameters associated with a network coordinator device. Note that different one or more predetermined operational parameters may be used to perform comparisons at or during different times, based on different operating conditions, and/or other consideration(s).

FIG. 6B is a diagram illustrating another example 602 of communication between wireless communication devices. In this diagram, at or during a time 1 (ΔT1), the device 310 support first communications based on a first communication protocol with device 390. During and while supporting these first communications, the device 310 also identify device 391 that operates based on a second communication protocol and determines one or more operational parameters associated with the device 391. The device then performs a comparison of the determined one or more operational parameters associated with the device 391 with one or more predetermined operational parameters.

When that comparison results in a favorable comparison (e.g., a threshold number of the one or more operational parameters associated with the second network coordinator device compares favorably with one or more predetermined operational parameters), then at or during a time 2 (ΔT2), the device 310 interworks the first communications based on the first communication protocol with the device 390 and second communications based on the second communication protocol with the device 391. From certain perspectives, the device 310 offloads at least some of the first communications supported with device 390 to the second communications supported with the device 391. In some examples, when the first communications degrade below an acceptable level of performance, the device 310 supports only the second communications. Similarly, if the second communications degrade below an acceptable level performance, the device 310 will revert to supporting only the first communications.

FIG. 6C is a diagram illustrating an example 603 of various types of operational parameters. Generally speaking, the operational parameters that are used to characterize one or more communication pathways between devices may be divided into two following categories: QoS Parameters and non-QoS parameters. Various examples of different types of operational parameters are provided below.

WLAN QoS parameters reflect the expected Quality of Service performance of a WLAN network. Some exemplary operational parameters are described as follows as follows:

BSS Load operational parameter contains the information on the current STA population and traffic levels in the BSS. BSS load information comprises information on Station Count (e.g., Total number of STAs currently associated with the BSS), Channel Utilization (e.g., the percentage of time that the AP (Access Point) sensed the medium was busy, as indicated by either the physical or virtual carrier sense (CS) mechanism), and Available Admission Capacity for All ACs (Access Categories) that specify the remaining amount of medium time available via explicit admission control, in units of 32 μs/s. BSS Load is also described in section 8.4.2.27 of [1] for additional details.

Link Throughput operational parameter is related to received signal strength indicator (RSSI) of the received frame transmitted by the non-Access point (AP) wireless station (STA) device to the AP (e.g., a query frame), and AP's estimate of the highest data rate that it supports for the communication link between the non-AP STA device and the AP.

Link Measurement operational parameter includes TPC (Transmit Power Control) report element, receive antenna ID, Transmit Antenna ID, RCPI and RSNI and other optional information. Link Measurement is also described in section 8.6.7.5 of [1] for additional details.

Channel Load operational parameter contains the proportion of measurement duration for which the measuring STA determined the channel to be busy. Channel Load is also described in section 8.4.2.21.5 of [1] for additional details.

QoS Traffic Capability operational parameter provides information about types of traffic generated by a non-AP QoS STA, and is used by a QoS AP to indicate the number of associated QoS STAs that have indicated QoS Traffic Capability of the corresponding UP/AC. QoS Traffic Capability is also described in section 8.4.2.77 of [1] for additional details.

BSS Average Access Delay operational parameter is a scalar indication of the relative level of the loading at an AP by measuring the delay between the time when a frame is ready for transmission to the time the frame actually starts the transmission. Non-QoS APs average the access delays for all DCF (distributed coordination function) transmitted frames, and QoS APs average the access delays for all EDCA (enhanced distributed channel access) transmitted frames of all ACs. BSS Average Access Delay is also described in section 8.4.2.38 of [1] for additional details.

BSS Available Admission Capacity per UP (User Priority) /AC (Access Category) operational parameter contains a list of Available Admission Capacity fields corresponding to different User Priorities and ACs). BSS Available Admission Capacity per UP (User Priority) /AC (Access Category) is also described in section 8.4.2.42 of [1] for additional details.

QLoad Report operational parameter provides information on the reporting AP's overlapping BSS situation, the reporting AP's QoS traffic load, and the total QoS traffic load of BSS directly overlapping the reporting AP's BSS. QLoad Report is also described in section 8.4.2.122 of [1] for additional details.

AC Station Count operational parameter indicates the number of associated STAs per AC. AC Station Count is also described in section 10.24.11 of [1] for additional details.

STA Statistics provides for each of various groups (e.g., Group 0, 1, . . . 16) of various statistics that reflect the performance of a BSS. STA Statistics is also described in section 8.4.2.21.9 and Table 8-97 of [1] for additional details.

AP Channel Report operational parameter contains a list of channels where a STA is likely to find an AP. AP Channel Report is also described in section 8.4.2.35 of [1] for additional details.

Neighbor Report contains information about known neighbor APs that are candidates for a service set transition. Each report describes an AP and consists of BSSID, BSSID Information, channel number, operating class, PHY type, and other information. Neighbor Report is also described in section 8.4.2.36 of [1] for additional details.

WAN Metrics operational parameters contain information about the capability of the backhaul link that connects a WLAN AP to the Internet, as specified in “WAN Metrics Hotspot 2.0 ANQP Element” in [2]. WAN Metrics are also described in section 4.4 of [2] for additional details.

Location Information operational parameter relates to a STA's location information expressed in various formats (e.g., Civic or Geospatial). The STA can be either an AP-STA or a non-AP-STA. Location Information is also described in section 8.4.2.21.10 and 8.4.2.21.13 of [1] for additional details.

In this disclosure, a new WLAN QoS Parameter, “Channel Utilization per AC,” is also specified. “Channel Utilization (for all ACs)” is part of the BSS Load in [1], as described above. “Channel Utilization per AC” indicates the percentage of time that the AP estimated the medium was busy due to the traffic from each AC (Access Category). Note that such ACs (Access Categories) correspond to voice, video, best effort, background, and also note that each AC may include data, media, information, etc. that is not specifically associated with that AC (e.g., the voice AC may carry or include video, the video AC may carry or include voice, etc.).

Channel(s) operational parameter contains information related to frequency band, channel, etc. used by a given network coordinator device to support communications based on a given communication protocol, standard, and/or recommended practice.

Sub-carrier(s) operational parameter contains information related to the sub-carrier assignment for one or more users within one or more frequency bands, channels, etc. such as based on OFDM and/or OFDMA signaling.

Note also that any other QoS and/or non-QoS parameter(s) may be used to determine whether or not to perform interworking of communications in any of the various examples described herein.

Note that the QoS and non-QoS parameters listed above and described in [1] [2], and/or [3] may be contained in various data structures such as an information element (IE), an information sub-element, a frame field, and/or other structures. The data structure/format used to contain the previously specified parameters or the new parameter in a query can be the same as an existing structure (e.g., such as described in [1] [2], and/or [3]) or a new structure without loss of generality. For example, a parameter that is contained in a sub-element in [1] [2], and/or [3] can be included in an information element or a frame field in a query frame. A query frame containing the parameters can be different from the frame specified in [1] [2], and/or [3] that contains the parameters. Also, note that various formats of a query frames can be used without loss of generality.

Various query protocols can be used to obtain these QoS and non-QoS parameters without loss of generality. An exemplary query protocol is an ANQP (Access Network Query Protocol) protocol specified in [1].

Note also that the QoS and non-QoS parameters described herein can also be used in conjunction with other information to facilitate interworking and network selection. For example, other information can be other WLAN capability information transmitted from the AP to the device (e.g., PHY rates supported by an AP). The other information can be the device's internal parameters (e.g., the “STA Statistics” collected by the device).

Note also that various embodiments, examples, and their equivalents as described herein may be adapted to performing interworking and network selection decision-making at a BA, an

AP, and/or a Control Unit. When the decision on interworking and network selection is made at an AP or some control unit outside an AP, the parameters collectable at a non-AP STA device can be transmitted from the non-AP STA device to the AP to assist the decision of the AP or the control unit outside the AP.

Again, note that any of the various WLAN QoS and/or non-QoS parameters listed above (e.g., including with reference to FIG. 6C) may be used to determine when and if to perform interworking of communications using two or more communication links with two or more network coordinator devices (e.g., BSs, APs, etc. or various types such as including one or more cellular BSs, one or more WLAN APs, etc.). Again, this disclosure specifies a new WLAN QoS parameter, Channel Utilization per AC operational parameter, and describes a novel approach which utilizes any combination of the existing and/or new parameters to facilitate interworking and network selection various usage scenarios.

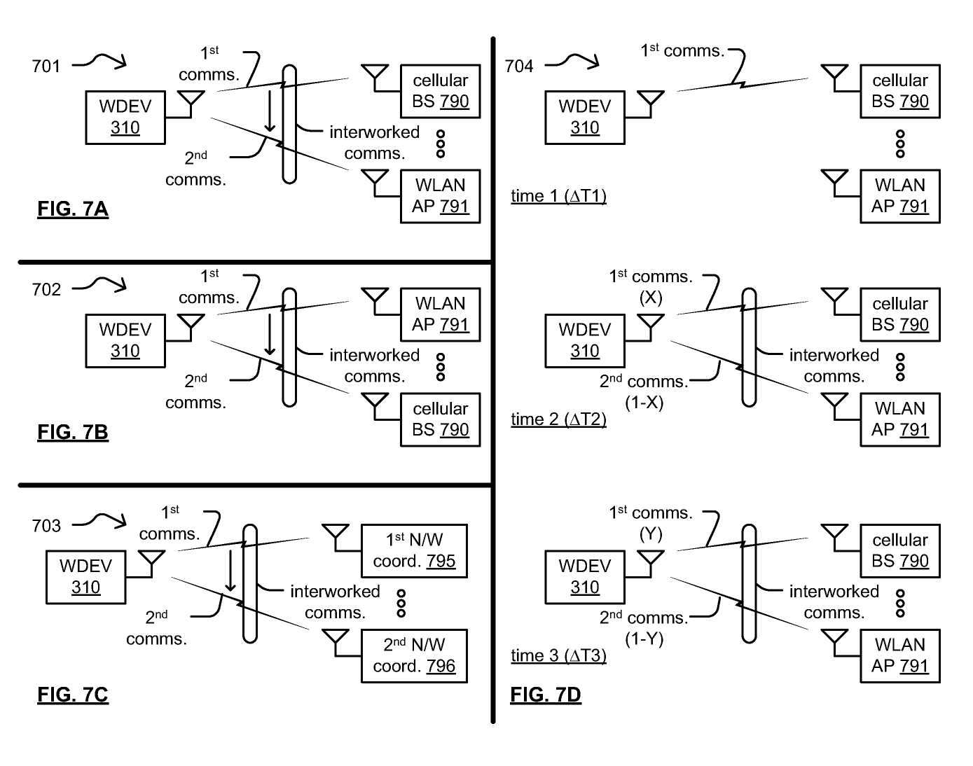

FIG. 7A is a diagram illustrating an example 701 of interworking communications using cellular and wireless local area network (WLAN) communications. This diagram describes interworking between a cellular network and a WiFi network where traffic is offloaded from a cellular network onto a WiFi network. In this example 701, the device 310's communication is carried over a cellular network via cellular BS 790. The device 310 performs scanning. While scanning, the device 310 finds one or more WLAN APs (e.g., including WLAN AP 791). The device queries the WLAN APs (e.g., including WLAN AP 791 using one or more of the various QoS and/or non-QoS parameters of each BS, AP, network coordinator device, etc. (e.g., either a subset or a full set of the various operational parameters described herein including those with reference to FIG. 6C).

Based on the parameters received in the query response, the device 310 decides whether to switch some or all its transmission control protocol/Internet protocol (TCP/IP), Internet protocol (IP), etc. flows from the cellular network to a WiFi network and also selects which WLAN BSS to switch to when multiple APs are present. The device 310 may also make a selection of a first WLAN AP based on the BSS with the highest expected link rate provided that sufficient bandwidth exists for the offload within that BSS. The device 310 may also make a selection for a secondary preference WLAN AP for another BSS that has lower reported neighbor interference, lower STA count and lower BSS average access delay, etc. In this example 701, he device 310 associates to the selected AP (e.g., WLAN AP 791 in this diagram), and the communication starts in the selected WLAN BSS.

FIG. 7B is a diagram illustrating another example 702 of interworking communications using cellular and WLAN communications. This diagram describes interworking between a cellular network and a WiFi network where traffic is offloaded from a WiFi network onto a cellular network. In this example 702, the device 310′s communication is carried over a WLAN or WiFi network via WLAN AP 791. The device 310 queries one or more APs to determine one or more of the various QoS and/or non-QoS parameters of each BS, AP, network coordinator device, etc. (e.g., either a subset or a full set of the various operational parameters described herein including those with reference to FIG. 6C).

Based on the parameters received in the query response, the device 310 decides whether to switch at least some (or all) of its communications onto the cellular network via cellular BS 790. The device 310 either disassociates from the existing WLAN AP 791 and switches the traffic entirely to a cellular network or offloads at least some of the TCP/IP, IP, etc. flows from the WLAN network via the WLAN AP 791 to the cellular network via cellular BS 790. The device 310 may also make its decision based on the current link rate within the BSS and/or increased neighbor interference or increased STA count or increased BSS average access delay, all identified through either received reports or through direct measurements made by the STA. The device 310 then starts communications in the cellular network via cellular BS 790.

On other examples, note also that when device 310 supports communications with a WLAN AP and if or when the device 310′s communication carried over a WiFi network experience performance degradation below an acceptable level of performance, then the device 310 performs scanning. While scanning, the device 310 finds one or more other WLAN APs in the area. The device 310 then queries those other APs using one or more of the various QoS and/or non-QoS parameters of each BS, AP, network coordinator device, etc. (e.g., either a subset or a full set of the various operational parameters described herein including those with reference to FIG. 6C).

Based on the parameters received in the query response, the device 310 decides whether to switch to another WLAN BSS and which WLAN BSS to switch to when multiple candidate APs are present. The device may make a selection first based on the BSS with the highest expected link rate provided that sufficient bandwidth exists for the offload within that BSS. With a secondary preference for a BSS that has lower reported neighbor interference, lower STA count and lower BSS average access delay. In such a situation, the device 310 associates to the selected AP, and the device 310 starts communications in the selected WLAN BSS.

FIG. 7C is a diagram illustrating an example 703 of interworking communications using communications associated with different network coordinator devices. This diagram describes general interworking between two separate wireless networks where traffic is offloaded from a first wireless network onto a second wireless network. In this example 702, the device 310′s communication is carried over a first wireless network via first network coordinator 795. The device 310 queries one or more BSs, APs, etc. to determine one or more of the various QoS and/or non-QoS parameters of each BS, AP, network coordinator device, etc. (e.g., either a subset or a full set of the various operational parameters described herein including those with reference to FIG. 6C).

Based on the parameters received in the query response, the device 310 decides whether to switch at least some (or all) of its communications onto the second wireless network. The device 310 either disassociates from the first network coordinator 795 and switches the traffic entirely to a cellular network or offloads at least some of the TCP/IP, IP, etc. flows from the first wireless network via the first network coordinator 795 to the second wireless network via second network coordinator 796.

FIG. 7D is a diagram illustrating another example 704 of interworking communications using communications associated with different network coordinator devices. In this diagram, at or during a first time 1 (ΔT1), the device 310 supports communications with a cellular network via the cellular BS 790.

Then, at or during a second time 2 (ΔT2), the device 310 supports interworks first and second communications with both the cellular network via the cellular BS 790 and also a WLAN network via the WLAN AP 791. The device 310 supports interworking based on a first operational parameter such that X amount of communications are supported via the first communications and 1−X amount of the communications are supported via the second communications. In total, the X and 1−X amount of the communications comprise 100% of the communications supported via the cellular BS 790 and also via the WLAN network via the WLAN AP 791. Generally speaking, the total amount of communications are apportioned between the first and second communications based on the X and 1−X amounts (e.g., X includes 70% of the total communications, and 1−X includes 30% of the total communications; alternatively, both X and 1−X each includes different 50% amounts of the total communications).

Then, at or during a second time 3 (ΔT3), the device 310 supports interworks first and second communications with both the cellular network via the cellular BS 790 and also a WLAN network via the WLAN AP 791. The device 310 supports interworking based on a first operational parameter such that Y amount of communications are supported via the first communications and 1−Y amount of the communications are supported via the second communications. In total, the Y and 1−Y amount of the communications comprise 100% of the communications supported via the cellular BS 790 and also via the WLAN network via the WLAN AP 791. Generally speaking, the total amount of communications are apportioned between the first and second communications based on the Y and 1−Y amounts (e.g., Y includes 60% of the total communications, and 1-Y includes 40% of the total communications). The apportionment of the communications at or during the second time 3 (ΔT3) is different than that which is performed at or during the second time 2 (ΔT2). Generally, any apportionment of the communications may be made at any time, such apportionment may be dynamic (e.g., different amounts at different times), etc.

Generally speaking, different apportionments of communications may be made between the different wireless networks at different times. The device 310 can adapt the apportionment based on any one or more considerations.

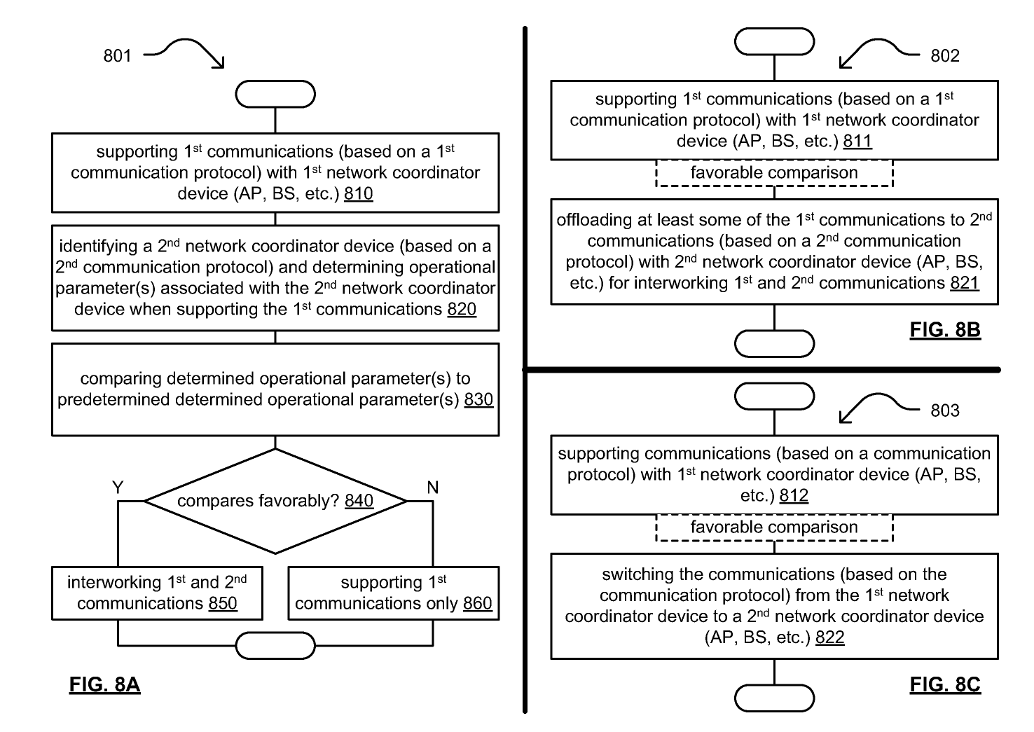

FIG. 8A is a diagram illustrating an embodiment of a method 801 for execution by one or more wireless communication devices.

The method 801 begins by supporting, via a communication interface of a wireless communication device, first communications based on a first communication protocol with a first network coordinator device (block 810).

The method 801 continues by identifying a second network coordinator device that operates based on a second communication protocol and determining one or more operational parameters associated with the second network coordinator device that operates based on the second communication protocol when supporting the first communications (block 820).

The method 801 continues by comparing the determined one or more operational parameters associated with the second network coordinator device that operates based on the second communication protocol with one or more predetermined operational parameters (block 830).

When the comparison is favorably as defined by some comparative analysis constraint (e.g., a threshold number of the one or more operational parameters associated with the second network coordinator device compares favorably with one or more predetermined operational parameters) (as per decision of block 840), the method 801 continues by interworking, via the communication interface of the wireless communication device, the first communications based on the first communication protocol with the first network coordinator device and second communications based on the second communication protocol with the second network coordinator device (block 850).

Alternatively, when the comparison is not favorably (as per decision of block 840), the method 801 continues supporting the first communications only (block 860).

FIG. 8B is a diagram illustrating another embodiment of a method 802 for execution by one or more wireless communication devices. The method 802 begins by supporting, via a communication interface of a wireless communication device, first communications based on a first communication protocol with a first network coordinator device (block 811). When a favorable comparison is made that indicates it is appropriate, allowable, or permissible to perform interworking, then the method 802 continues by offloading at least some of the first communications to second communications (e.g., based on a second communication protocol) with a second network coordinator device (AP, BS, etc.) for interworking the first and second communications (block 821).

FIG. 8C is a diagram illustrating another embodiment of a method 803 for execution by one or more wireless communication devices. The method 803 begins by supporting, via a communication interface of a wireless communication device, first communications based on a first communication protocol with a first network coordinator device (block 812). When a favorable comparison is made that indicates that the quality of the first communications has degraded below an acceptable level of performance, then the method 803 continues by switching the communications (based on the communication protocol, i.e., the same communication protocol) from the first network coordinator device to a second network coordinator device (AP, BS, etc.) (block 822). For example, the first communications based on the first communication protocol with the first network coordinator device may be based on a WLAN communication standard with a first WLAN AP, and the second communications based on the second communication protocol with the second network coordinator device may be based on the same WLAN communication standard with another, second WLAN AP.

It is noted that the various operations and functions described within various methods herein may be performed within a wireless communication device (e.g., such as by the processor 330, communication interface 320, and memory 340 as described with reference to FIG. 3A) and/or other components therein. Generally, a communication interface and processor in a wireless communication device can perform such operations.

Examples of some components may include one of more baseband processing modules, one or more media access control (MAC) layer components, one or more physical layer (PHY) components, and/or other components, etc. For example, such a processor can perform baseband processing operations and can operate in conjunction with a radio, analog front end (AFE), etc. The processor can generate such signals, packets, frames, and/or equivalents etc. as described herein as well as perform various operations described herein and/or their respective equivalents.

In some embodiments, such a baseband processing module and/or a processing module (which may be implemented in the same device or separate devices) can perform such processing to generate signals for transmission to another wireless communication device using any number of radios and antennae. In some embodiments, such processing is performed cooperatively by a processor in a first device and another processor within a second device. In other embodiments, such processing is performed wholly by a processor within one device.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to,” “operably coupled to,” “coupled to,” and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to,” “operable to,” “coupled to,” or “operably coupled to” indicates that an item includes one or more of power connections, input(s), output(s), etc., to perform, when activated, one or more its corresponding functions and may further include inferred coupling to one or more other items. As may still further be used herein, the term “associated with,” includes direct and/or indirect coupling of separate items and/or one item being embedded within another item.

As may be used herein, the term “compares favorably” or equivalent, indicates that a comparison between two or more operational parameters, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module,” “processing circuit,” “processor,” and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments of an invention have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples of the invention. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module includes a processing module, a processor, a functional block, hardware, and/or memory that stores operational instructions for performing one or more functions as may be described herein. Note that, if the module is implemented via hardware, the hardware may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure of an invention is not limited by the particular examples disclosed herein and expressly incorporates these other combinations.

What is claimed is:

1. A wireless communication device comprising:
a communication interface; and
a processor, the processor and the communication interface configured to:
support first communications based on a first communication protocol with a first network coordinator device;
identify a second network coordinator device that operates based on a second communication protocol and determine one or more operational parameters associated with the second network coordinator device that operates based on the second communication protocol when supporting the first communications; and
interwork the first communications based on the first communication protocol with the first network coordinator device and second communications based on the second communication protocol with the second network coordinator device when a threshold number of the one or more operational parameters associated with the second network coordinator device compares favorably with one or more predetermined operational parameters.

2. The wireless communication device of claim 1, wherein the processor and the communication interface are further configured to:
scan for and identify a plurality of network coordinator devices that operate based on the second communication protocol when supporting the first communications; and
identify the second network coordinator device from among the plurality of network coordinator devices that operate based on the second communication protocol based on the threshold number of the one or more operational parameters associated with the second network coordinator device comparing favorably with the one or more predetermined operational parameters.

3. The wireless communication device of claim 1, wherein the processor and the communication interface are further configured to:
support only the first communications based on the first communication protocol with the first network coordinator device and identify a third network coordinator device that operates based on the second communication protocol when supporting the first communications when less than the threshold number of the one or more operational parameters associated with the second network coordinator device compares favorably with the one or more predetermined operational parameters;
determine another one or more operational parameters associated with the third network coordinator device that operates based on the second communication protocol when supporting only the first communications; and
interwork the first communications based on the first communication protocol with the first network coordinator device and third communications based on the second communication protocol with the third network coordinator device when another threshold number of the another one or more operational parameters associated with the third network coordinator device compares favorably with the one or more predetermined operational parameters.

4. The wireless communication device of claim 1, wherein the one or more operational parameters associated with the second network coordinator device includes a channel utilization per access category operational parameter that indicates a percentage estimate amount of time that the second network coordinator device is busy on a communication medium for communications each of one or more access categories.

5. The wireless communication device of claim 1, wherein the one or more operational parameters associated with the second network coordinator device includes a channel utilization per access category operational parameter that indicates a percentage estimate amount of time that the second network coordinator device is busy on a communication medium for communications each of one or more access categories and at least one of a basic services set (BSS) load operational parameter, a link throughput operational parameter, a link measurement operational parameter, a channel load operational parameter, a Quality of Service (QoS) traffic capability operational parameter, a BSS average access delay operational parameter, a BSS available admission capacity per user priority (UP)/AC (Access Category) operational parameter, a Qload report operational parameter, an AC station count operational parameter, a wireless station (STA) statistics operational parameter, an access point (AP) channel report operational parameter, a neighbor report operational parameter, a wide area network (WAN) metrics operational parameter, or a location information operational parameter.

6. The wireless communication device of claim 1, wherein the processor and the communication interface are further configured to:
interwork, when the threshold number of the one or more operational parameters associated with the second network coordinator device compares favorably with the one or more predetermined operational parameters, the second communications with the first communications using an interworking parameter that is based on a total number of the one or more operational parameters associated with the second network coordinator device that compares favorably with one or more predetermined operational parameters including to:
interwork the second communications with the first communications based on a first interworking parameter when the total number of the one or more operational parameters associated with the second network coordinator device that compares favorably with one or more predetermined operational parameters is within a first predetermined range; and
interwork the second communications with the first communications based on a second interworking parameter when the total number of the one or more operational parameters associated with the second network coordinator device that compares favorably with one or more predetermined operational parameters is within a second predetermined range.

7. The wireless communication device of claim 1, wherein the communication interface further comprises:
a first transceiver configured to support the first communications based on the first communication protocol; and
a second transceiver configured to support the second communications based on the second communication protocol.

8. The wireless communication device of claim 1 further comprising:
a mobile unit, wherein the first network coordinator device includes a cellular base station (BS) that operates based on a cellular communication protocol, and the second network coordinator device includes a wireless local area network (WLAN) access point (AP) that operates based on a WLAN communication protocol.

9. The wireless communication device of claim 1 further comprising:
a mobile unit, wherein the first network coordinator device includes a wireless local area network (WLAN) access point (AP) that operates based on a WLAN communication protocol, and the second network coordinator device includes a cellular base station (BS) that operates based on a cellular communication protocol.

10. A wireless communication device comprising:
a communication interface; and
a processor, the processor and communication interface configured to:
support first communications based on a first communication protocol with a first network coordinator device;
identify a second network coordinator device that operates based on a second communication protocol and determine first one or more operational parameters associated with the second network coordinator device that operates based on the second communication protocol when supporting the first communications;
identify a third network coordinator device that operates based on the first communication protocol and determine second one or more operational parameters associated with the third network coordinator device that operates based on the first communication protocol when supporting the first communications;
interwork the first communications based on the first communication protocol with the first network coordinator device and second communications based on the second communication protocol with the second network coordinator device when a first threshold number of the one or more operational parameters associated with the second network coordinator device compares favorably with one or more predetermined operational parameters; and
interwork the first communications based on the first communication protocol with the first network coordinator device and third communications based on the first communication protocol with the third network coordinator device when a second threshold number of the one or more operational parameters associated with the third network coordinator device compares favorably with the one or more predetermined operational parameters.

11. The wireless communication device of claim 10, wherein the processor and the communication interface are further configured to:
monitor performance status of the first communications based on the first communication protocol with the first network coordinator device; and
identify at least one of the second network coordinator device that operates based on the second communication protocol or the third network coordinator device that operates based on the first communication protocol when the performance status of the first communications degrades below a performance threshold.

12. The wireless communication device of claim 10, wherein the processor and the communication interface are further configured to:
monitor performance status of the first communications based on the first communication protocol with the first network coordinator device; and
terminate the first communications and support third communications based on the first communication protocol with the third network coordinator device when the second threshold number of the one or more operational parameters associated with the third network coordinator device compares favorably with the one or more predetermined operational parameters and when the performance status of the first communications degrades below a performance threshold.

13. The wireless communication device of claim 10 further comprising:
a mobile unit, wherein the first network coordinator device includes a wireless local area network (WLAN) access point (AP) that operates based on a WLAN communication protocol, the second network coordinator device that operates based on the second communication protocol includes a cellular base station (BS) that operates based on a cellular communication protocol, and the third network coordinator device includes another WLAN access point AP that operates based on the WLAN communication protocol.

14. A method for execution by a wireless communication device, the method comprising:
supporting, via a communication interface of the wireless communication device, first communications based on a first communication protocol with a first network coordinator device;
identifying a second network coordinator device that operates based on a second communication protocol and determining one or more operational parameters associated with the second network coordinator device that operates based on the second communication protocol when supporting the first communications; and
interworking, via the communication interface of the wireless communication device, the first communications based on the first communication protocol with the first network coordinator device and second communications based on the second communication protocol with the second network coordinator device when a threshold number of the one or more operational parameters associated with the second network coordinator device compares favorably with one or more predetermined operational parameters.

15. The method of claim 14 further comprising:
scanning for and identify a plurality of network coordinator devices that operate based on the second communication protocol when supporting the first communications; and
identifying the second network coordinator device from among the plurality of network coordinator devices that operate based on the second communication protocol based on the threshold number of the one or more operational parameters associated with the second network coordinator device comparing favorably with the one or more predetermined operational parameters.

16. The method of claim 14, wherein the one or more operational parameters associated with the second network coordinator device includes a channel utilization per access category operational parameter that indicates a percentage estimate amount of time that the second network coordinator device is busy on a communication medium for communications each of one or more access categories.

17. The method of claim 14, wherein the one or more operational parameters associated with the second network coordinator device includes a channel utilization per access category operational parameter that indicates a percentage estimate amount of time that the second network coordinator device is busy on a communication medium for communications each of one or more access categories and at least one of a basic services set (BSS) load operational parameter, a link throughput operational parameter, a link measurement operational parameter, a channel load operational parameter, a Quality of Service (QoS) traffic capability operational parameter, a BSS average access delay operational parameter, a BSS available admission capacity per user priority (UP)/AC (Access Category) operational parameter, a Qload report operational parameter, an AC station count operational parameter, a wireless station (STA) statistics operational parameter, an access point (AP) channel report operational parameter, a neighbor report operational parameter, a wide area network (WAN) metrics operational parameter, or a location information operational parameter.

18. The method of claim 14 further comprising:
interworking, when the threshold number of the one or more operational parameters associated with the second network coordinator device compares favorably with the one or more predetermined operational parameters, the second communications with the first communications using an interworking parameter that is based on a total number of the one or more operational parameters associated with the second network coordinator device that compares favorably with one or more predetermined operational parameters.

19. The method of claim 14, wherein the wireless communication device includes a mobile unit, the first network coordinator device includes a cellular base station (BS) that operates based on a cellular communication protocol, and the second network coordinator device includes a wireless local area network (WLAN) access point (AP) that operates based on a WLAN communication protocol.

20. The method of claim 14, wherein the wireless communication device includes a mobile unit, wherein the first network coordinator device includes a wireless local area network (WLAN) access point (AP) that operates based on a WLAN communication protocol, and the second network coordinator device includes a cellular base station (BS) that operates based on a cellular communication protocol.
